(19) United States
(12) Patent Application Publication
(10) Pub. No.: US 2013/0246192 A1
(43) Pub. Date: Sep. 19, 2013

(54) SYSTEM FOR ENABLING AND INCENTIVIZING ADVERTISEMENTS IN CROWDSOURCED VIDEO SERVICES

(71) Applicants: Antti Eronen, Tampere (FI); Jussi Leppänen, Tampere (FI)

(72) Inventors: Antti Eronen, Tampere (FI); Jussi Leppänen, Tampere (FI)

(73) Assignee: Nokia Corporation, Espoo (FI)

(21) Appl. No.: 13/418,488

(22) Filed: Mar. 13, 2012

(51) Int. Cl. G06Q 30/02

(52) U.S. Cl. 705/14.72

(57) ABSTRACT

An apparatus comprising at least one processor and at least one memory including computer program code, the at least one memory, computer program code, and processor configured to cause the apparatus to receive a first media content that is being captured by the apparatus. The apparatus may be configured to receive an insertion indication from the user of a portion of the first media content at which a second media content is to be inserted to enable a combination of the second media content with the first media content. The apparatus may be configured to cause the first media content and at least one of the insertion indication or a composite media content comprising the first media and second media content to be transmitted. Corresponding methods and computer program products are also provided.

### TECHNOLOGICAL FIELD

An example embodiment of the present invention relates generally to techniques for providing insertion of advertisements into user generated media, and more particularly, relates to an apparatus, a method, and a computer program product for indicating a region of interest in a user generated source media for the insertion of an advertisement.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Further, mobile terminals now include capabilities to capture media content, such as photographs, video recordings and/or audio recordings. As such, users may now have the ability to record media whenever users have access to an appropriately configured mobile terminal. Accordingly, multiple users may attend an event with each user using a different mobile terminal to capture various media content of the event activities. The captured media content may include redundant content. In addition, some users may capture media content of particular unique portions of the event activity such that each user has a unique perspective and/or view of the event activity. Thereby, the entire library of captured content by multiple users may be compiled together to provide a composite media content comprising multiple content media captured by different users of the particular event activity.

Currently, business advertisement and revenue streams are underdeveloped for user generated media, and more specifically, for composite media content comprising user generated media. A user may capture user-generated media content, such as a video recording, of an event activity from a unique angle such that the user-generated media content does not optimally capture sponsorship logos or other advertisements located at the event activity. Further, user-generated media content and/or composite media content of an event activity may be barred from distribution as sponsors or other advertisers would not receive recognition and/or exposure in some user-generated media content and/or composite media content.

### BRIEF SUMMARY

A method, apparatus and computer program product therefore provide for inserting media content, such as an advertisement, into user-generated media content captured at an event activity or other event by any number of devices. For example, methods, apparatuses and computer program products of one example embodiment may provide for indicating a region of interest in a user-generated media content, such as video and/or audio data, and the insertion of media content, such as an advertisement, sponsorship logos and/or the like into the user-generated media content to create a composite media content for distribution.

In a first example embodiment, an apparatus comprises at least one processor and at least one memory including computer program code with the at least one memory and the computer program code configured to, with the processor, cause the apparatus to receive a first media content that is being captured by the apparatus. In addition, the at least one memory and the computer program code may be configured to, with the processor, cause the apparatus to receive an insertion indication from the user of a portion of the first media content at which a second media content is to be inserted to enable a combination of the second media content with the first media content. Further still, the at least one memory and the computer program code may be configured to, with the processor, cause the apparatus to cause the first media content and at least one of the insertion indication or a composite media content comprising the first and second media content to be transmitted.

In another example embodiment, a method may include receiving a first media content that is being captured by an apparatus. The method may also comprise receiving an insertion indication from the user of a portion of the first media content at which a second media content is to be inserted to enable a combination of the second media content with the first media content. Additionally, the method may include causing the first media content and at least one of the insertion indication or a composite media content comprising the first and second media content to be transmitted.

In another example embodiment, a computer program product is provided. The computer program product of the example embodiment may include at least one non-transitory computer-readable storage medium having computer-readable program instructions stored therein. The computer-readable program instructions may comprise program instructions configured to cause an apparatus to perform a method comprising receiving a first media content that is being captured by the apparatus. The method may also comprise receiving an insertion indication from the user of a portion of the first media content at which a second media content is to be inserted to enable a combination of the second media content with the first media content. Additionally, the method may include causing the first media content and at least one of the insertion indication or a composite media content comprising the first and second media content to be transmitted.

In another example embodiment, an apparatus may provide means for receiving an indication corresponding to a user identity. Further, the apparatus may include means for providing a first media content that is being captured by the apparatus. The apparatus may also comprise means for receiving an indication from the user of a portion of the first media content for inserting a second media content such that the second media content is combined with the first media content. Additionally, the apparatus may include means for providing a composite media content comprising the first and second media content. Further still, the apparatus may comprise means for receiving reward data specific to the user.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWINGS

Having thus described example embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of a mobile terminal according to an example embodiment of the present invention;

FIG. 3 illustrates a schematic block diagram of an apparatus configured to capture user generated source media content and to receive an indication of a selected area for insertion of an advertisement according to an example embodiment of the present invention;

FIG. 4a illustrates an apparatus configured to capture user generated source media content and a selected area of interest for the insertion of an advertisement according to an example embodiment of the present invention;

FIG. 4b illustrates an apparatus configured to display an advertisement inserted into a user generated source media content according to one embodiment of the present invention;

FIG. 4c illustrates an apparatus configured to capture user generated source media content and a selected area of interest for the insertion of an advertisement according to example embodiments;

FIG. 4d illustrates an apparatus configured to capture user generated source media content and a selected area of interest for the insertion of an advertisement according to example embodiments;

FIG. 4e illustrates an apparatus configured to display an advertisement inserted into a user generated source media content according to example embodiments;

FIG. 4f illustrates an apparatus configured to display an advertisement inserted into a user generated source media content according to example embodiments; and

FIG. 5 illustrates a flowchart detailing a method according to one example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

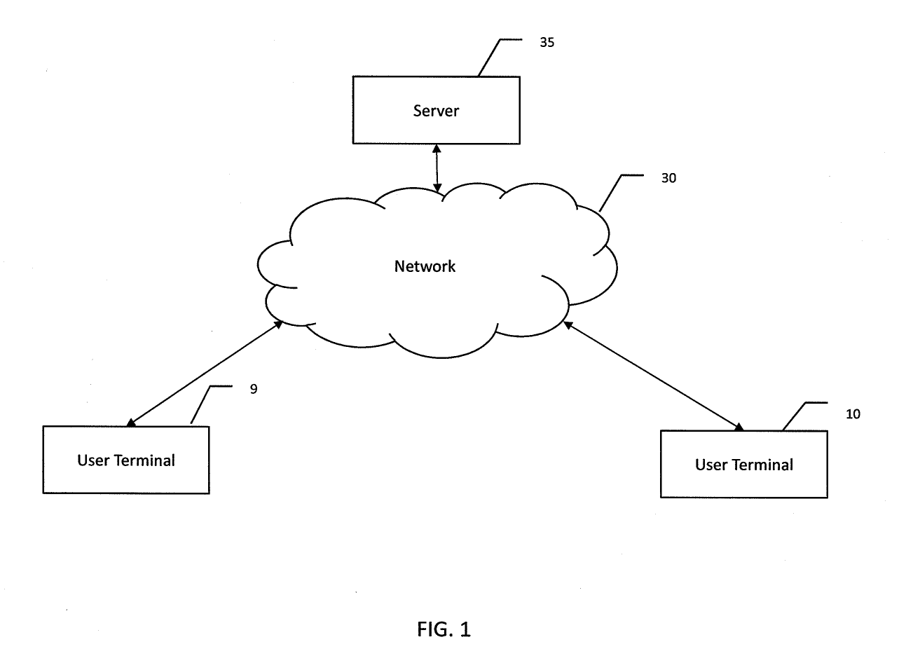

As indicated above, some embodiments of the present invention may be employed in methods, apparatuses and computer program products configured to provide for the insertion of a second media content, such as an advertisement into a first media content, such as a user generated media content or a user captured media content, and more particularly, may be configured to provide for indicating a region of interest in a user generated source media for the insertion of an advertisement. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a plurality of user terminals 9, 10. A user terminal 10 may be any of multiple types of fixed or mobile communication and/or computing devices such as, for example, personal digital assistants (PDAs), pagers, mobile televisions, mobile telephones, gaming devices, laptop computers, tablet computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, such as other user terminals, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as universal mobile telecommunications system (UMTS), wideband code division multiple access (W-CDMA), CDMA2000, time division-synchronous CDMA (TD-CDMA), global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to capture media content, such as pictures, video and/or audio recordings. As such, the system may additionally comprise at least one composite media server 35 which may be configured to receive a first and or second media content from any one of the user terminals 9, 10, either directly or via the network 30. In some embodiments, the composite media server 35 may be embodied as a single server, server bank, or other computer or other computing devices or node configured to transmit and/or receive composite media content, a first media content, and/or a second media content received by any number of user terminals. As such, for example, the composite media server may include other functions or associations with other services such that composite media content, a first media content and/or a second media content stored on the composite media server may be provided to other devices, other than the user terminal which originally captured the first, second, and or composite media content. Thus, the composite media server may provide public access to composite media content received from any number of user terminals. Although illustrated in FIG. 1 as a single server, in some embodiments the composite media server 25 comprises a plurality of servers.

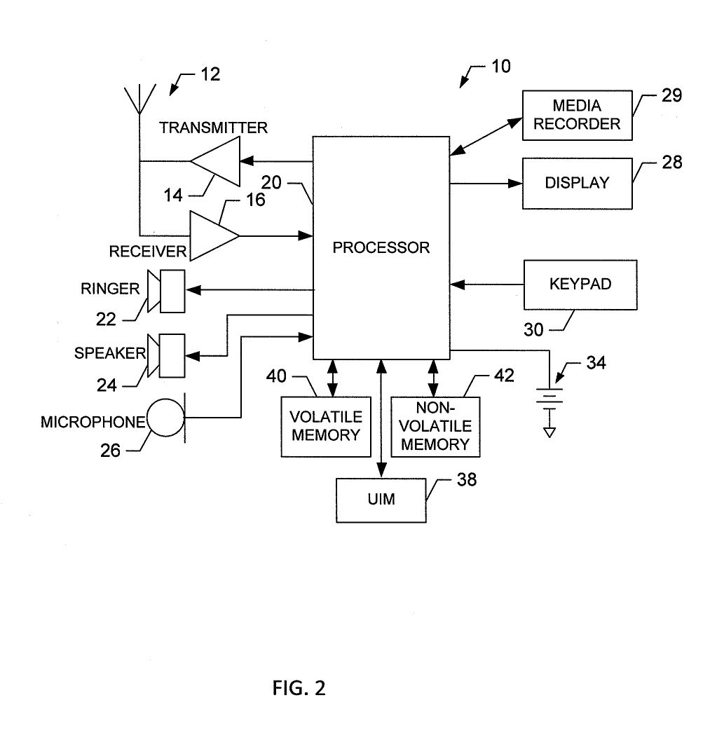

FIG. 2 illustrates a block diagram of a mobile user terminal 10 that would benefit from embodiments of the present invention. Indeed, the mobile user terminal 10 may serve as the user terminal in the embodiment of FIG. 1 so as to capture media content and transmit such content to a composite media server. It should be understood, however, that the mobile user terminal 10 as illustrated and hereinafter described is merely illustrative of one type of device that may serve as the user terminal and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

As shown, the mobile user terminal 10 may include an antenna 12 (or multiple antennas 12) in communication with a transmitter 14 and a receiver 16. The mobile user terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local area network (WLAN) techniques such as Institute of Electrical and Electronics Engineers (IEEE) 802.11, 802.16, and/or the like. In addition, these signals may include media content data, user generated data, user requested data, and/or the like. In this regard, the mobile user terminal may be capable of operating with one or more air interface standards, communication protocols, modulation types, access types, and/or the like. Some Narrow-band Advanced Mobile Phone System (NAMPS), as well as Total Access Communication System (TACS), mobile user terminals may also benefit from embodiments of this invention, as should dual or higher mode phones (e.g., digital/analog or time division multiple access (TDMA)/code division multiple access (CDMA)/analog phones). Additionally, the mobile user terminal 10 may be capable of operating according to Wi-Fi or Worldwide Interoperability for Microwave Access (WiMAX) protocols.

It is understood that the processor 20 may comprise circuitry for implementing audio/video and logic functions of the mobile user terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the mobile user terminal 10 to transmit and receive web content, such as location-based content, according to a protocol, such as Wireless Application Protocol (WAP), hypertext transfer protocol (HTTP), and/or the like. The mobile user terminal 10 may be capable of using a Transmission Control Protocol/Internet Protocol (TCP/IP) to transmit and receive web content across the internet or other networks.

The mobile user terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, the media recorder 29, the keypad 30 and/or the like. In addition, the processor 20 may further comprise user interface circuitry configured to control at least some functions of one or more elements of the user interface, such as a media recorder 29 configured to capture media content. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile user terminal may comprise a battery for powering various circuits related to the mobile user terminal, for example, a circuit to provide mechanical vibration as a detectable output. The display 28 of the mobile user terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display. The user input interface may comprise devices allowing the mobile user terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile user terminal.

The mobile user terminal 10 may comprise memory, such as a user identity module (UIM) 38, a removable user identity module (R-UIM), and/or the like, which may store information elements related to a mobile subscriber. In addition to the UIM, the mobile user terminal may comprise other removable and/or fixed memory. The mobile user terminal 10 may include non-transitory volatile memory 40 and/or non-transitory, non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile user terminal for performing functions of the mobile user terminal. For example, the memories may comprise an identifier, such as an international mobile equipment identification (IMEI) code, capable of uniquely identifying the mobile user terminal 10.

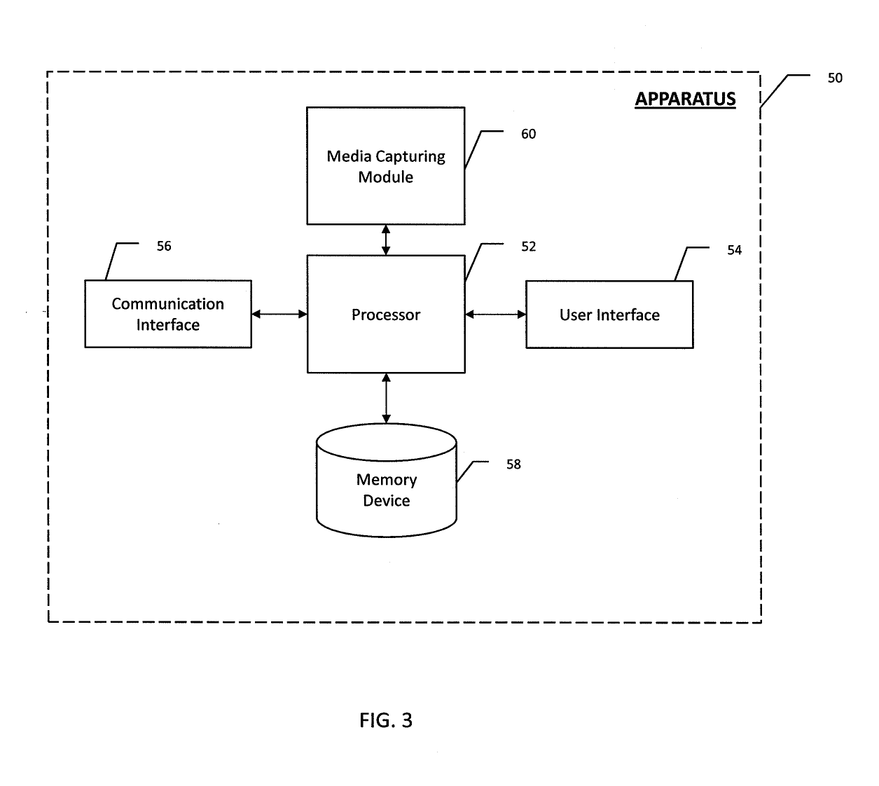

In an example embodiment, an apparatus 50 is provided that may be employed by devices performing example embodiments of the present invention. The apparatus 50 may be embodied, for example, as any device hosting, including, controlling, comprising, or otherwise forming a portion of the user terminal 10 and/or the composite media server 35. However, embodiments may also be embodied on a plurality of other devices such as for example where instances of the apparatus 50 may be embodied by a network entity. As such, the apparatus 50 of FIG. 3 is merely an example and may include more, or in some cases less, than the components shown in FIG. 3.

With further regard to FIG. 3, the apparatus 50 may include or otherwise be in communication with a processor 52, an optional user interface 54, a communication interface 56 and a non-transitory memory device 58. The memory device 58 may be configured to store information, data, files, applications, instructions and/or the like. For example, the memory device 58 could be configured to buffer input data for processing by the processor 52. Alternatively or additionally, the memory device 58 could be configured to store instructions for execution by the processor 52. In an instance in which the apparatus 50 is embodied by a user terminal 10, the apparatus may also include a media capturing module 60, such as a camera, a video camera, a microphone, and/or any other device configured to capture media content, such as pictures, audio recordings, video recordings and/or the like.

As mentioned above, in some embodiments, the apparatus 50 may be embodied by a user terminal 10, the composite media server 35, or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 52 may be embodied in a number of different ways. For example, the processor 52 may be embodied as one or more of various hardware processing means such as a co-processor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. As such, in some embodiments, the processor 52 may include one or more processing cores configured to perform independently. A multi-core processor may enable multiprocessing within a single physical package. Additionally or alternatively, the processor 52 may include one or more processors configured in tandem via the bus to enable independent execution of instructions, pipelining and/or multithreading.

In an example embodiment, the processor 52 may be configured to execute instructions stored in the memory device 58 or otherwise accessible to the processor. The processor 52 may also be further configured to execute hard coded functionality. As such, whether configured by hardware or software methods, or by a combination thereof, the processor 52 may represent an entity (for example, physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor to perform the algorithms and/or operations described herein when the instructions are executed. However, in some cases, the processor 52 may be a processor of a specific device (for example, a user terminal, a network device such as a server, a mobile terminal, or other computing device) adapted for employing embodiments of the present invention by further configuration of the processor by instructions for performing the algorithms and/or operations described herein. The processor 52 may include, among other things, a clock, an arithmetic logic unit (ALU) and logic gates configured to support operation of the processor.

Meanwhile, the communication interface 54 may be any means such as a device or circuitry embodied in either hardware, software, or a combination of hardware and software that is configured to receive and/or transmit data from/to a network and/or any other device or module in communication with the apparatus 50. In this regard, the communication interface 54 may include, for example, an antenna (or multiple antennas) and supporting hardware and/or software for enabling communications with a wireless communication network (for example, network 30). In fixed environments, the communication interface 54 may alternatively or also support wired communication. As such, the communication interface 54 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 54 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further be configured to transmit and/or receive media content, such as a picture, video and/or audio recording. In one embodiment, the communication interface 56 may be configured to transmit and/or receive a media content package comprising a plurality of data, such as a plurality of pictures, videos, audio recordings and/or any combination thereof. In this regard, the processor 52, in conjunction with the communication interface 56, may be configured to transmit and/or receive a composite media content package relating to media content captured at a particular event, location, and/or time, in addition to a second media content, such as an advertisement. Accordingly, the processor 52 may cause the composite media content to be displayed upon a user interface 54, such as a display and/or a touchscreen display. In this regard, the media content package may be displayed as a first media content captured by a user and a second media content comprising an advertisement superimposed over the first media content in a location indicated by the user. Additionally and/or alternatively, in some embodiments, the apparatus 50 may be configured to transmit and/or receive a second media content, such as an advertisement, and the apparatus 50 may be configured to superimpose the second media content over a first media content, such as a user-captured video recording.

Although the apparatus 50 need not include a user interface 54, such as in instances in which the apparatus is embodied by a composite media server 35, the apparatus of other embodiments, such as those in which the apparatus is embodied by a user terminal 10, may include a user interface. In those embodiments, the user interface 54 may be in communication with the processor 52 to receive an indication of a user input at the user interface 54 and/or to provide an audible, visual, mechanical or other output to the user. As such, the user interface 54 may include, for example, a keyboard, a mouse, a joystick, a display, a touch screen, a microphone, a speaker, or other input/output mechanisms. Alternatively or additionally, the processor 52 may comprise user interface circuitry configured to control at least some functions of one or more elements of the user interface 54, such as, for example, the speaker, the ringer, the microphone, the display, and/or the like. The processor 52 and/or user interface circuitry comprising the processor 52 may be configured to control one or more functions of one or more elements of the user interface 54 through computer program instructions (e.g., software and/or firmware) stored on a memory accessible to the processor 52 (e.g., memory device 58, and/or the like). In another embodiment, the user interface 54 may be configured to record and/or capture media content as directed by a user. Accordingly, the apparatus 50, such as the processor 52 and/or the user interface 54, may be configured to capture media content with a camera, a video camera, and/or any other image data capturing device and/or the like. Further, the user interface 54 may include a touch screen display configured to receive an indication of an area of the media content being displayed and/or captured suitable for insertion of an advertisement and/or other media content.

In one embodiment, the media content that is captured may include a device-specific user identifier that provides a unique identifier as to when the media content was captured and by whom or what device captured the media content. In this regard, the apparatus 50 may include a processor 52, user interface 54, and/or media capturing module 60 configured to provide a user identifier associated with media content captured by the apparatus 50.

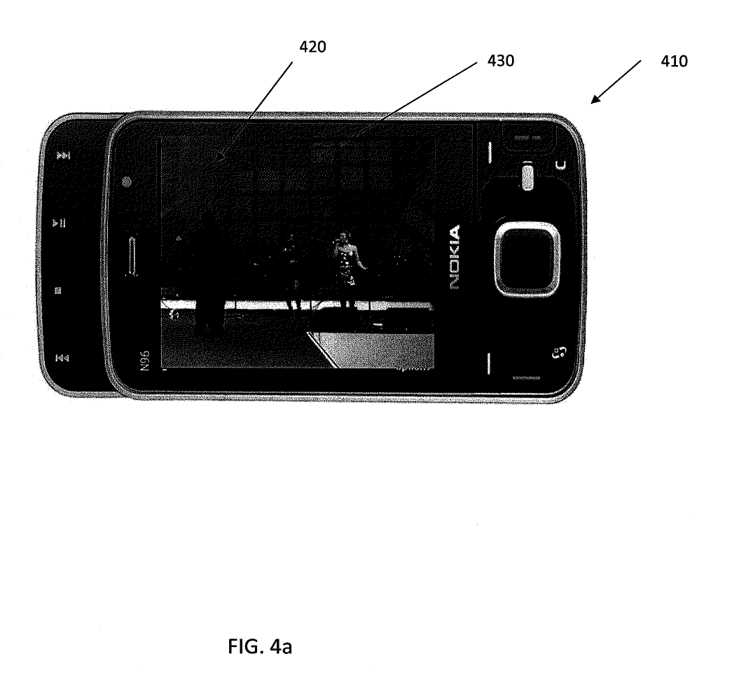

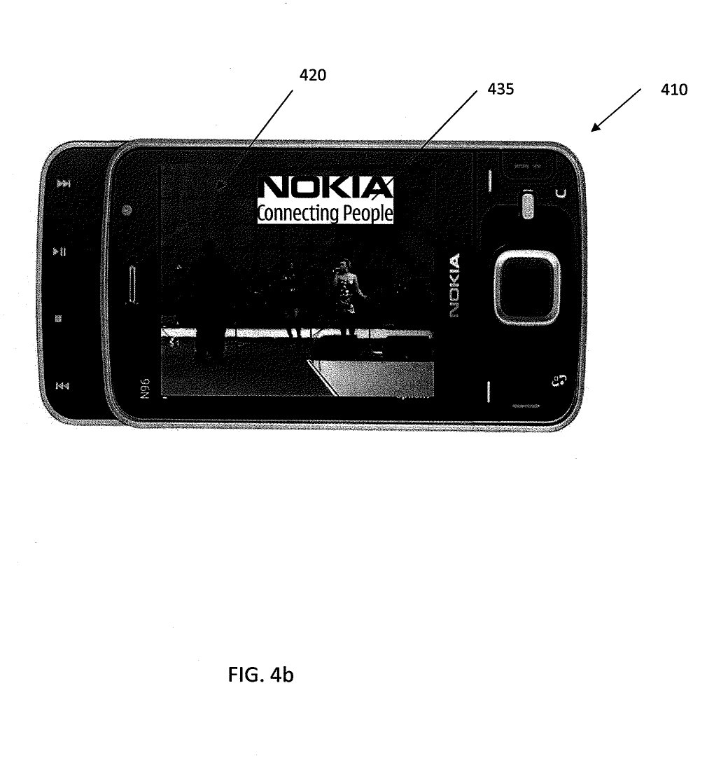

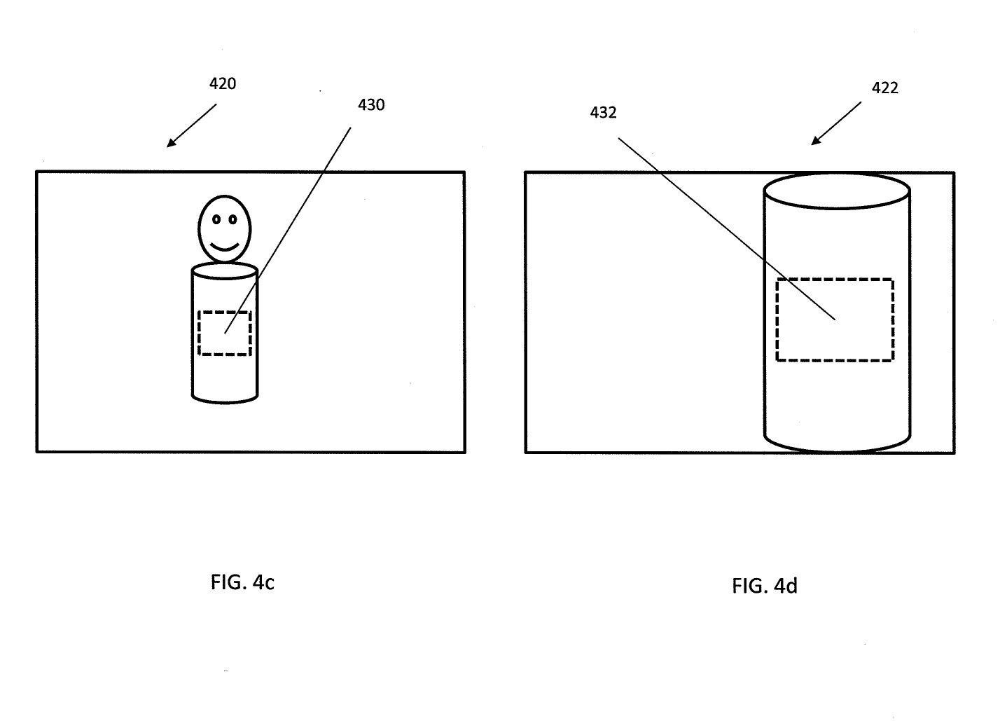

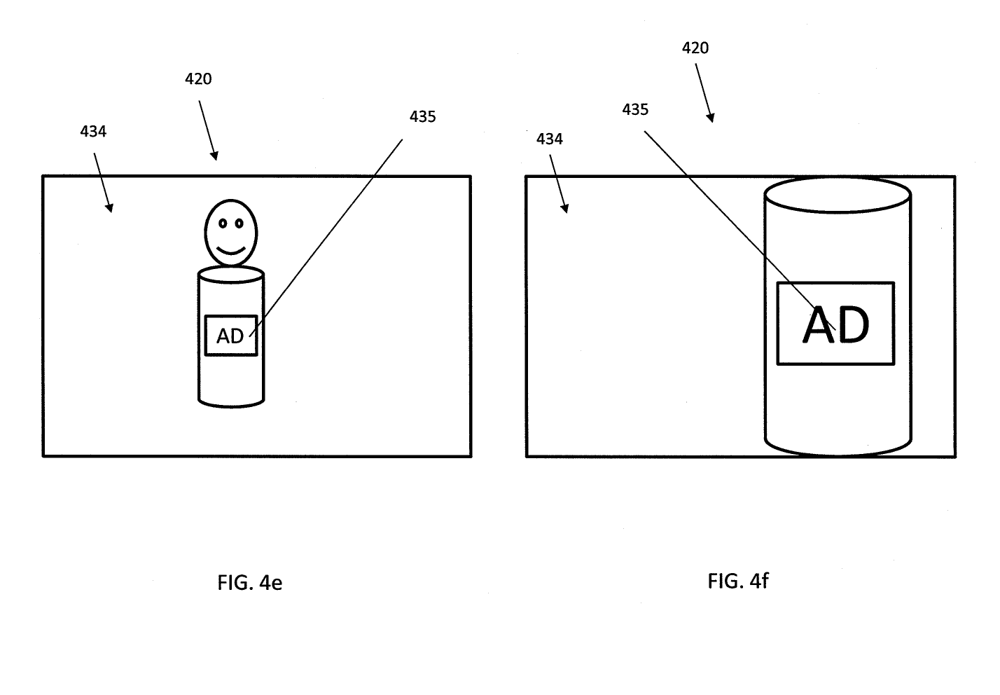

FIGS. 4a and 4b illustrate an apparatus 410 according to one embodiment of the present invention. The apparatus 410 may include a user interface 420, such as a touch screen display. The apparatus 410 may be configured to capture, display, and/or otherwise provide a media content via the user interface 420. According to one example embodiment of the present invention, a user may capture media content with the apparatus 410, and may further indicate a portion 430 of the media content that is displayed upon the user interface 420 that is suitable for insertion of an advertisement and/or other media content. For example, a user may capture the media content and simultaneously indicate the area and/or portion 430 of the user interface 420 displaying the media content that is suitable for insertion of the advertisement. In another embodiment, a user may capture the media content and then subsequently review the media content for indicating a portion 430 of the media content for insertion of the second media content, such as an advertisement.

According to one embodiment, once a user has indicated a portion 430 of the media content displayed on the user interface 420 that is suitable for insertion of the second media content, the user may upload the user-generated media content to a composite media content server and/or the like for analysis, review, and/or distribution. Along with the user-generated media content, insertion data, which may include data indicating the point where a second media content, such as an advertisement, may be inserted may be transmitted to a remote computing device, such as a composite media content server. The insertion data may include a time stamp relative to the beginning of the media file and coordinates describing the region of the video frame where the advertisement is to be inserted. The insertion data may be included as metadata in the user-generated media content or may be transmitted separated from the user-generated media content. In some embodiments where the insertion data is transmitted separately from the user-generated media content, the insertion data may further include media content identifying data, such as a file name, which may link the insertion data to the appropriate user-generated media content. In one example embodiment, the composite media content server may be configured to transmit the composite media, which may include the first media content comprising the user-generated and/or captured media content and the second media content comprising the advertisement, sponsorship information, and/or the like. In some embodiments, the composite media content server may be configured to transmit composite media, which may include a single media content created by the composite media content server. For example, the composite media content server may be configured to provide the second media content to a user terminal so as to be overlaid on to the user-generated media content. In another embodiment, the composite media content server may be configured to transmit composite media, which may include a single media content. For example, a single media content may include a combination of the first and second media content into a single media content, such as a single video recording. As shown in FIG. 4b, the apparatus 410 may be configured to display the second media content 435, such as the advertisement, on the user interface 420 of the apparatus 410. In another embodiment, the apparatus 410 may be configured to compile a composite media content comprising the first and second media content to a composite media content server. As such, the apparatus may be configured to receive an indication of a selected portion of the first media content for insertion of an advertisement, insert a second media content overlapping the first media content, and transmit the composite media content comprising the first and second media content. In another example embodiment, the apparatus may be configured to transmit to a composite media content server a first media content and insertion data comprising a location within the first media content suitable for insertion of the second media content.

The composite media content server may further be configured to select a second media content, such as an advertisement, superimpose the second media content onto the first media content to create a single media content, such as a single video file, and then transmit the single media content to the apparatus 410 for viewing. For example, in some embodiments, the composite media content server may be in communication, either wired or wirelessly, with an advertisement database containing a memory device configured to store data corresponding to particular advertisements that may be inserted into a user-generated media content. According to one embodiment, the data corresponding to advertisements for insertion into a first media content may be stored on a memory device of the composite media content server. Additionally and/or alternatively, the composite media content server may be configured to receive insertion data regarding a position, location, time and/or the like for inserting an advertisement into a first media content captured by a user. The insertion data may further include data corresponding to a recommendation for an advertisement type to be inserted into the first media content. For example, a user may be capturing a video recording of a concert when an artist smashes his guitar on stage. Accordingly, the user may provide the user generated media content with insertion data, which may include data indicating an advertisement for guitars and/or other musical instruments would be appropriate.

Embodiments of the present invention provide for insertion of a second media content into a first media content captured by a user terminal at a particular event. The first media content captured by different devices may be transmitted to a composite media content server, in addition to insertion data corresponding to locations within the first media content suitable for insertion of the second media content. The first and second media contents according to embodiments of the present invention may include picture data, video data, audio data, and/or the like. Accordingly, FIG. 4b illustrates the insertion of a second media content overlapping, overwriting or otherwise replacing (hereinafter generally referenced as “overlapping”) the first media content captured by a user terminal. In one example embodiment, a first user may capture the first media content and provide an indication for a portion of the first media content suitable for insertion of the second media content, such as the advertisement. Further, a second user may capture media content of the same event activity from a different perspective that still includes the portions indicated by the first user suitable for insertion of the second media content, but the second user may fail to indicate that the portion of the first media content captured by the first user corresponding to the media content captured by the second user is suitable for insertion of an advertisement. The first user may transmit the first media content and the insertion data corresponding to the portion of the first media content suitable for insertion of the advertisement to the composite media content server, while the second user transmits media content captured by the second user. In such an embodiment, the composite media content server may be configured to compile the first media content and the additional media content captured by the second user into a continuous stream of media, and may further be configured to insert the second media content overlapping the continuous stream of media at the location indicated by the first user. In another embodiment, the second user may provide the additional media content, and the first user may provide a first media content and insertion data to the composite media content server. The composite media content server may include logic and be configured to determine that the additional media content provided by the second user is of higher quality or more desirable. Further, the additional media content captured by the second user and the first media content captured by the first user may include the same region, area, or portion captured. As such, the composite media content server may select the additional media content and utilize the insertion data from the first user to create a composite media content, wherein the composite media content includes the additional media content captured by the second user and the second media content, such as an advertisement or the like, which is inserted and/or overlaps the first media content at the indicated location provided by the insertion data. Accordingly, the composite media content server may be configured to transmit the compiled continuous stream of media content comprising the user captured media with the second media content inserted therein.

According to some embodiments, the composite media content server may be configured to determine when to insert a second media content into a first media content so as to provide a composite media content. For example, the composite media content server may be configured to receive insertion data from a first user indicating that an advertisement and/or other media content should be inserted into the first media content, such as a user-captured video recording of a concert. In one embodiment, the user may provide insertion data indicating a second media content, such as an audio recording and/or the like, should be inserted into the first media content. Accordingly, the composite media content server may insert an audio track overlapping the recorded audio track of the user-captured video recording. Additionally and/or alternatively, the composite media content server may be configured to determine that the insertion of an audio track overlapping the recorded audio track of the user-captured video recording may be undesirable. For example, the user may provide insertion data indicating an audio track should be inserted over a portion of the audio track of the user-captured video recording when the portion includes a video and audio recording of an artist performing a song at a concert. As such, the composite media server may be configured to determine that the insertion data indicating that a second media content, such as an audio recording, should be inserted over the audio track of the video recording of the performance would be undesirable. In addition, according to one embodiment, the composite media server may be configured to determine an appropriate portion of a first media content for the insertion of a second media content. For example, the composite media content server may be configured to determine that the portions in between songs performed by an artist at a concert would be a desired portion for the insertion of a second media content, such as an audio advertisement. Additionally and/or alternatively, in one embodiment, the composite media content server may be configured to determine and/or classify the audio track of a first media content so as to determine portions of the first media content appropriate for insertion of a second media content, such as an audio advertisement.

FIGS. 4c, 4d, 4e and 4f illustrate an apparatus according to some embodiments described herein. Specifically, FIGS. 4c, 4d, 4e and 4f illustrate a user interface 420 of a first and second apparatus configured to capture user-generated media content at an event. Specifically, FIG. 4c illustrates a first user capturing user-generated media content of an event activity on a first apparatus and displayed upon the user interface 420. In addition, the first user may indicate a portion 430 of the media content that is displayed upon the user interface 420 that is suitable for insertion of an advertisement and/or other media content. As illustrated in FIG. 4d, while the first user captures media content and indicates a portion 430 of the media content suitable for insertion of an advertisement and/or other media content, a second user may capture media content of the same event activity as captured by the first user with the first apparatus from a different angle, zoom and/or view, as displayed on the user interface 422 of the second apparatus. In one embodiment, the second user may indicate a portion 432 of the media content captured by the second user as suitable for insertion of an advertisement and/or the like. Although FIG. 4d illustrates a second user indicating a portion 432 of the media content captured by the second user as a suitable portion for insertion of an advertisement and/or the like, in another embodiment, the second user may provide the user-generated media content to the composite media content server without the indication data corresponding to the portion of the user-generated media content captured by the second user.

According to some embodiments, a first user may provide a media content captured by the first user and may further provide insertion data corresponding to a portion of the media content suitable for insertion of an advertisement and/or the like. The second user may provide a media content captured by the second user, wherein the media content captured by both the first user and the second user focus on an event activity but from differing viewpoints, zoom levels, angles and/or the like. In one embodiment, the composite media content server may be configured to align the media contents provided by both the first and second users. As such, the composite media content server may be configured to provide a composite media content comprising portions of the media content captured by both the first and second users. In some embodiments, the composite media content may include a portion of the media content captured by the first user followed by a portion of the media content captured by the second user. In another embodiment, the composite media content may switch between portions of the media content captured by the first user and media content captured by the second user. In some embodiments, the composite media content server may be configured to provide a composite media content comprising portions of the media content captured by the first and/or second user and a second media content 435, such as an advertisement, inserted into a portion of the first media content in accordance with insertion data provided by the first user.

According to some embodiments, the composite media content server may be configured to insert the second media content 435 into a media content provided by the first user in accordance with the insertion data provided by the first user. Additionally and/or alternatively, the composite media content server may be configured to recognize portions of the media content captured by the second user focus on the same event activity captured in portions of the media content captured by the first user. As such, the composite media content server may be configured to insert the second media content 435 into a media content provided by the second user in accordance with the insertion data provided by the first user. As illustrated in FIGS. 4e, a composite media content 434 may be displayed upon a user interface 420 containing portions of media content captured by a first user that includes a second media content 435. Additionally and/or alternatively, the composite media content 434 may include a subsequent portion of composite media content comprising portions of the media content captured by a second user, as shown in FIG. 4f. Although the media content captured by the second user focuses on the same event activity as captured by the media content captured by the first user, the second user may have captured media content of the event activity at a different angle, view, zoom level and/or the like. Accordingly, the composite media content server may be configured to alter the second media content 435 to correspond to the different angle, view, zoom level and/or the like as provided by the media content captured by the second user.

In some embodiments, the composite media server may be configured to scale, rotate, and/or manipulate the second media content 435 such that the second media content 435 is displayed corresponding to the angle, view, zoom level and/or the like of the media content captured by the second user. According to some embodiments, the composite media content server may correlate and/or align audio tracks of media content captured by different users to determine the alignment of media content. In some embodiments, the composite media content server may be configured to recognize visual objects in media content, such as video recordings, and identify the same visual objects in other media content. Additionally and/or alternatively, user-generated media content may include location data corresponding to global positioning, compass orientation and/or the like. Further, media content may include timestamp data indicating when the media content was originally captured. Accordingly, the composite media content server may be configured to utilize the location data to determine if media content captured by a first user corresponds with media content captured by any other user.

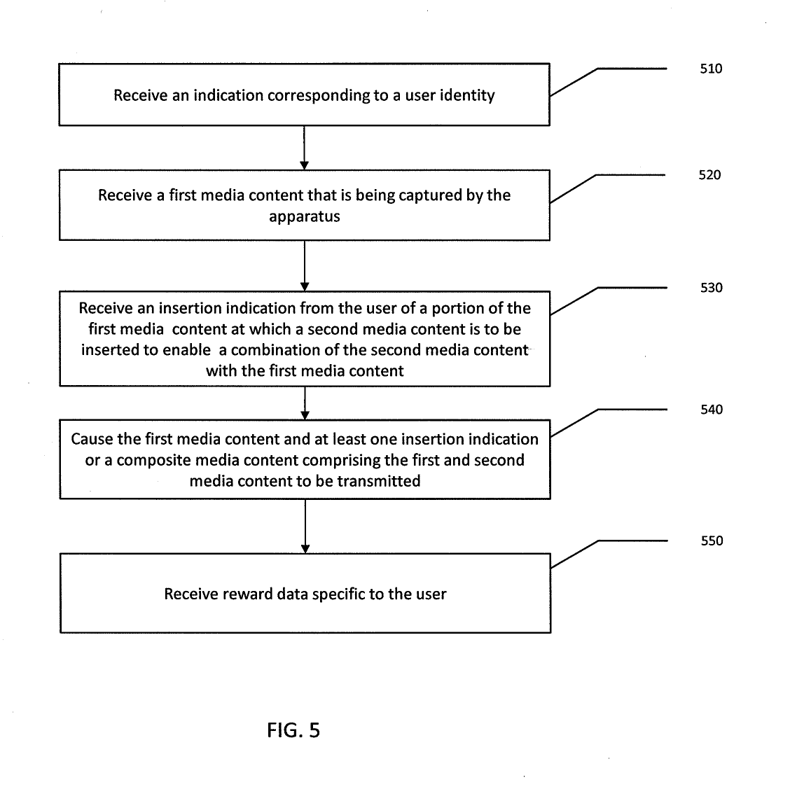

As such, this insertion of the second media content into the first media content provides for the additional commercialization of user generated media captured by any number of devices at a particular event. FIG. 5 is a flowchart of a system, method and program product according to example embodiments of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include receiving an indication corresponding to a user identity at operation 510. In this regard, the apparatus 50 may include means, such as the user interface 54, the processor 52, the communication interface 56 and/or the like for receiving an indication of the user identity operating the apparatus 50. In one embodiment, the apparatus 50 may be linked to a single user such that any media content captured by the apparatus is attributed to the single user. In another example embodiment, the apparatus 50 may be configured to request a user identity when a media content is captured and transmitted to a composite media content server.

Further, the method may include providing a first media content that is captured by the apparatus at operation 520. In this regard, the apparatus 50 may include means, such as the media capturing module 60, the processor 52 and/or the user interface 54 for capturing, displaying, and/or otherwise providing a first media content to a user. The apparatus may be configured to capture the first media content, such as video recording, a picture, and/or an audio recording or the like. The apparatus may be further configured to display the first media content in real-time as the first media content is being captured by a media capturing module.

The method may further include receiving an indication from the user of a portion of the first media content for inserting a second media content such that the second media content is combined with the first media content at operation 530. The apparatus 50 may therefore also include means, such as the user interface 54, the memory device 58, the processor 52, the communication interface 56 and/or the like for receiving an indication from the user corresponding to a portion of the first media content that is suitable for insertion of the second media content, such as an advertisement. In one embodiment, the apparatus may include a touchscreen display configured to receive an indication of a portion of the first media content suitable for insertion of advertisements and/or other media content. For example, an apparatus may be configured to display the first media content on a touchscreen display as the first media content is being captured. Concurrently to displaying the first media content, the touchscreen display may further be configured to receive a touch input indicating an area of the first media content suitable for insertion of the advertisement and/or other media content. In one example embodiment, a user may outline, draw, or otherwise indicate a specific area of the first media content suitable for insertion of the second media content. Further, the insertion data may be included as metadata of the first media content.

In addition, the insertion data may further comprise data corresponding to the length in time the second media content and/or advertisement should be displayed. Optionally or alternatively, the composite media content server may determine the length in time the second media content should be displayed, and may overrule the user's indication for the length of time the second media content should be displayed. For example, a user may submit a first media content and indication data comprising data that a second media content should be located at a particular location and/or portion of the first media content for a period of time of approximately 30 seconds before a particular event occurs. In such an embodiment, the composite media content server may decide and overrule the user's indication data and compile a composite media content wherein the second media content is displayed for approximately 1 minute before the particular event occurs at the location indicated by the user.

In another embodiment, the apparatus may be configured to select a second media content from a local memory device for insertion into the first media content. The local memory device may include a number of advertisements and/or other media content that is suitable for insertion into the first media content. In one embodiment, the apparatus may be further configured to determine an appropriate media content for insertion based at least in part on the size of the indicated portion and/or location of the first media content for insertion of the second media content. In another embodiment, the composite media content server may be configured to determine the appropriate second media content for insertion into the first media content. Further still, in another embodiment, the composite media content server may be configured to select a number of different media contents for insertion into the same indicated location and/or portion of the first media content. For example, a composite media content server may be configured to display a first advertisement at the indicated location for a first period of time, a second advertisement at the indicated location for a second period time, and a third advertisement at the same indicated location for a third period of time. One skilled in the art may appreciate the composite media content server may be configured to display any number of advertisements or other media content at the indicated location through the duration of the first media content.

Additionally, the method may include providing a composite media content comprising the first and second media content at operation 540. In this regard, the apparatus 50 may include the processor 52, the user interface 54, the communication interface 56, the memory device 58 and/or the like for providing the composite media content. In one embodiment, the apparatus may be configured to compose the composite media content and insert the second media content overlapping the first media content before transmitting the composite media content to a composite media content server. In another embodiment, the apparatus may be configured to transmit the first media content and insertion data corresponding to a position indicated by the user as suitable for insertion of an advertisement or other media content. In such an embodiment, the composite media content server may be configured to receive the first media content and the insertion data, analyze the insertion data for an appropriate media content and/or advertisement, select a second media content for insertion, compile the composite media content comprising the first and second media content, and transmit the composite media content to the apparatus and/or other users requesting the composite media content. Accordingly, in such an embodiment, the apparatus may be configured to display the composite media content to the user via the user interface, such as a touchscreen display. Additionally or alternatively, the composite media content server may be configured to store and/or transmit to another database the composite media content such that a repository of composite media content is created. As such, other users may access the composite media content at their convenience and view the composite media content that includes the advertisements and/or other media content.

In addition, the method may also comprise receiving reward data specific to the user at operation 550. In this regard, the apparatus 50 may include the processor 52, the user interface 54, the communication interface 56, the memory device 58, and/or the like. In one embodiment, the apparatus may be linked, paired, or otherwise associated with a single user such that when a user transmits a first media content and indication data to a composite media content server, the server is able to identify which user submitted the media content. When the composite media content server transmits the composite media content comprising the first media content and the second media content, the composite media content server may be configured to capture, record, or otherwise track how many times the composite media content is transmitted, to whom the composite media content is transmitted to, and/or which users access the composite media content. Once the composite media content has been viewed or accessed by a user other than the original user who submitted the first media content and the indication data, the composite media content server may be configured to submit data to the apparatus and/or other computing device indicating the original user has been given a reward. In one embodiment, the composite media content server may be configured to provide reward data to the first user that submits the first media content and indication data. As such, when two or more users provide a first media content and indication data for the same or similar location captured by respective devices, the composite media content server may be configured to provide a reward to the user who submitted the media content first. In another embodiment, the composite media content server may be configured to reward a user who provides insertion data related to a first media content whenever any composite media content containing portions of the first media content and a second media content inserted within the composite media content according to the insertion data is transmitted and/or viewed by other users. Example rewards may include small monetary rewards and/or credits to an online internet store allowing for the purchases of electronic books, music, games, and/or other content and the like. In one embodiment, a user may be able to receive the composite media content from the composite media content server, view the composite media content, and vote on the appropriateness and/or suitability of the advertisement content, location, and/or the like. As such, a first user may submit the first media content and insertion data to the composite media content server, and a second user may receive the composite media content comprising the first media content and the advertisement. The second user may believe the location detracts from the event activity recorded in the first media content and vote negatively to reflect such. In such an embodiment, the first user may be rewarded with a smaller reward or no reward at all. Additionally and/or alternatively, the composite media content server may be configured to disregard insertion data related to the first media content and not attach or compile a composite media content containing a second media content corresponding to the insertion data. In some embodiments, the composite media content server may be configured to initially provide a composite media content containing second media content corresponding to the insertion data, and then subsequently provide composite media content without the second media content and/or media content related to the insertion data. In another embodiment, a second user may find the advertisement was useful and/or appropriate and vote positively to indicate approval. As such, the first user may be rewarded with a greater reward than if the second user had voted negatively.

In some embodiments, the first media content may merely include an audio recording. As such, a user may indicate whether the second media content, such as another audio recording, should be inserted and overlaid on a right channel, left channel, or both channels of a stereo recording of the first media content. In some embodiments, the first media content may be a video recording and the second media content may be an audio recording. Accordingly, a user may provide insertion data corresponding to an initial time in the video recording appropriate for insertion of the second media content (i.e., an audio recording) and an end time in the video recording wherein the second media content ceases to play. Additionally and/or alternatively, the composite media content server may be configured to determine whether the volume on an audio track of the first media content (i.e., the video recording) should be decreased when the second media content (i.e., the audio recording) is combined and played with the first media content. Further, a user may indicate how long the second media content should be inserted and whether the volume of the first media content should be decreased such that the second media content may be heard over the first media content.

Some advantages of embodiments of the present invention may include the further commercialization and distribution of user-generated media content of an event activity. Further advantages include providing a reward mechanism for incentivizing users to indicate areas of user generated media suitable for insertion of second media content and/or advertisements. In addition, another advantage may include incentivizing users to record media content and/or transmit media content to a remote device for further distribution and/or storage.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
receive a first media content that is being captured by the apparatus;
receive an insertion indication from the user of a portion of the first media content at which a second media content is to be inserted to enable a combination of the second media content with the first media content; and
cause the first media content and at least one of the insertion indication or a composite media content comprising the first and second media content to be transmitted.

2. The apparatus of claim 1, wherein the second media content comprises an advertisement.

3. The apparatus of claim 1, wherein the first and second media content comprise a visual media content.

4. The apparatus of claim 1, wherein any one of the first and second media content comprise an audio media content.

5. The apparatus of claim 1 further configured to cause the first media content and at least one of the insertion indication or composite media content to be transmitted to a remote computing device.

6. The apparatus of claim 5 further configured to:
receive a second composite media content; and
cause the composite media content to be provided to the user for review.

7. The apparatus of claim 1 further configured to:
receive an indication corresponding to the user identity; and
receive reward data specific to the user.

8. A method comprising:
receiving a first media content that is being captured by the apparatus;
receiving an insertion indication from the user of a portion of the first media content at which a second media content is to be inserted to enable a combination of the second media content with the first media content; and
causing the first media content and at least one of the insertion indication or a composite media content comprising the first and second media content to be transmitted.

9. The method of claim 8, wherein the second media content comprises an advertisement.

10. The method of claim 8, wherein the first and second media content comprise a visual media content.

11. The method of claim 8, wherein any one of the first and second media content comprise an audio media content.

12. The method of claim 8 further comprising causing the first media content and at least one of the insertion indication or the composite media content to be transmitted to a remote computing device.

13. The method of claim 12 further comprising:
receiving a second composite media content; and
causing the composite media content to be provided to the user for review.

14. The method of claim 8 further comprising:
receiving an indication corresponding to a user identity; and
receiving reward data specific to the user.

15. A computer program product comprising at least one non-transitory computer-readable storage medium having computer-readable program instructions stored therein, the computer-readable program instructions comprising program instructions configured to cause an apparatus to perform a method comprising:
receiving a first media content that is being captured by the apparatus;
receiving an insertion indication from the user of a portion of the first media content at which a second media content is to be inserted to enable a combination of the second media content with the first media content; and
causing the first media content and at least one of the insertion indication or a composite media content comprising the first and second media content to be transmitted.

16. The computer program product of claim 15, wherein the second media content comprises an advertisement.

17. The computer program product of claim 15, wherein the first and second media content comprise a visual media content.

18. The computer program product of claim 15, wherein any one of the first and second media content comprise an audio media content.

19. The computer program product of claim 15 further configured to cause an apparatus to perform a method comprising transmitting the first media content and at least one of the insertion indication or the composite media content to a remote computing device.

20. The computer program product of claim 19 further configured to cause an apparatus to perform a method comprising:
receiving a second composite media content; and
causing the composite media content to be provided to the user for review.
